(19) United States
(12) Patent Application Publication
(10) Pub. No.: US 2006/0168892 A1
(43) Pub. Date: Aug. 3, 2006

(54) Motor vehicle door

(76) Inventors: Hilmar Dohles, Itzgrund (DE); Thomas Haubold, Mainleus (DE); Rolf Bucker, Bamberg (DE); Michael Eisentraudt, Stockheim (DE); Thomas Pohl, Grossenseebach (DE); Werner Stammberger, Weissenbrunn (DE)

Correspondence Address: CHRISTIE, PARKER & HALE, LLP, PO BOX 7068, PASADENA, CA, 91109-7068, US

(21) Appl. No.: 10/536,868

(22) PCT Filed: Nov. 18, 2003
(86) PCT No.: PCT/DE03/03843

§ 371 Date: Dec. 28, 2005

(30) Foreign Application Priority Data
Nov. 29, 2002 (DE) 102 56 131.1

(51) Int. Cl. B60J 1/16

(52) U.S. Cl. 49/374; 49/502

(57) ABSTRACT

A motor vehicle door with a door body includes a door outer shell and a door inner shell between which a window lifter for lifting and lowering a window pane is configured within a door shaft. A component disposed inside the door shaft presents a crosslink between the window pane or the window lifter and at least one door shell. As an antitheft protection the component rests against the window pane or the window lifter under prestress and is swiveled, when the window pane is lifted, from the door shaft into a positive lock position with the door shell by a catch or support disposed on the window pane. In order to improve lateral and front-crash protection, the component is linked with the window pane and establishes a positive or negative lock between the door shells in a defined position of the window pane.

### CROSS-REFERENCE TO RELATED APPLICATION

This application claims priority of German Patent Application Number 102 56 131.1, filed on Nov. 29, 2002.

### BACKGROUND

The invention relates to a motor vehicle door.

A motor vehicle door 1 consists in accordance with the perspective exploded view of FIG. 1 and the longitudinal sectional view through a motor vehicle door according to FIG. 2 of door shells 11, 12 which are connected together and of which the door outer shell or the door outside panel 11 is adapted to the vehicle body and the door inner shell or door inside panel 12 is connected to a door inside trim 13. Between the door outer shell 11 and the door inner shell 12 is a door shaft 10 in which different door assemblies, including inter alia a window lifter 3 for lifting and lowering a window pane 2 from and into the door shaft 10, are mounted on a door module support. The upper closure of the door shaft 10 is formed by a door shaft strip 14 through which the window pane exits from the door shaft 10 when lifted through the window lifter 3 and closes a door opening which is provided above the door shaft 10.

The arrangement of the window pane 2 which is movable up and down by the window lifter 3 means that a structural connection between the door outer shell 11 and the door inner shell 12 inside the door shaft 10 is not possible since the door blank or door body is in two parts as a result of the window pane 2 and window lifter 3, so that both the door outer shell 11 and the door inner shell 12 with their inherent rigidity define the door blank and its stiffness, which would be significantly higher if the door outer shell and door inner shell were joined through a force-locking connection. The rigidity of the vehicle door is therefore reduced compared to the vehicle body since the latter permits a force-locking connection between the outer shell and inner shell and thus offers greater impact protection in the event of side and front crash situations.

To adapt the side and front impact safety of a vehicle door to the vehicle body would only be possible by using stronger materials for the door shells or by additionally reinforcing the door outer shell 11 and door inner shell 12. However these two steps would clearly increase the weight of the vehicle door.

A further problem when designing motor vehicle doors lies in the fact that the upper door shaft strip 14 represents a weak spot both in relation to weather factors and in relation to break-in security. Despite the arrangement of sealing elements which sealingly adjoin the window pane 2 there is the risk of damp entering into the door shaft 10, particularly in the case of old or damaged sealing elements. In order to prevent the door closing mechanism being broken into from outside, which is very simple through the open door shaft strip 14, lock covers have to be provided at considerable effort and cost but which do at least impede a vehicle break-in.

The object of the present invention is to increase the security of a vehicle door without restricting the space requirement and mobility of the window lifter or window pane.

### BRIEF DESCRIPTION

The solution according to the invention ensures increased security for the door body of a motor vehicle door without restricting the functions of or placing structural restrictions on the window lifter or window pane of a motor vehicle door

By connecting the window pane or window lifter to the door outer shell and/or door inner shell reinforcement elements of the door body can be connected together so that the door body acts as one closed unit. Through a force-locking and/or positive locking connection of the window pane or window lifter to the door outer shell and/or door inner shell or of the door outer shell directly to the door inner shell, an increased inherent rigidity is achieved which in the event of side and front impact crash situations clearly increases the safety of the motor vehicle door without having to provide additional reinforcement means on the door outer shell and/or door inner shell or having to increase the strength of the material of the door shells itself. The force-transferring component part can be fixed directly on the window lifter or directly on the window pane and can assist the structure of the door body to withstand the strain of tension or pressure in the upper stop of the window lifter or during the lifting of the window pane.

Even with a sole arrangement of a force-transferring component part between the window pane or window lifter and one of the two door shells the solution according to the invention increases the security of the vehicle door against break-in since the component part closes the upper opening of the door shaft and thus blocks access to the door lock through the door shaft strip. Additional security measures to protect the door lock for example by means of a door lock cover are thus unnecessary.

Accordingly at least one component part is connected to a door shell and is supported with spring tension against the window pane or window lifter.

The component part can be formed as a part which changes its position during the movement of the window pane or window lifter and which at a predetermined position of the window pane or window lifter is connected with positive engagement to a door shell. More particularly the component part can bear against the window pane or window lifter with pretension and as the window pane or window lifter is raised from the door shaft can swivel into a force-transferring position with a door shell by means of a follower or bearing mounted on the window pane or window lifter.

In this variation of the solution according to the invention the component part has in particular a length-variable swivel arm and a bridging arm connected to the swivel arm whose one end bears through a slide member against the window pane or window lifter and whose other end engages in a rear-cut section of the door shell to connect with a door shell at a predetermined position of the window pane or window lifter. The swivel arm can thereby be designed as a telescopic arm and can be attached to a door shell and pretensioned through a torsion spring against the window pane or window lifter.

In an alternative embodiment the component part can be movable substantially at right angles to the window pane or window lifter and supported with spring tension against the window pane or window lifter whereby the component part in the fully raised position of the window pane or window lifter bears against a follower or support bearing connected to the window pane or window lifter.

With the above embodiments the component part can be connected to a windscreen wiper or washer device and can thus easily fulfil an additional function.

The solution according to the invention enables alternatively or additionally to a pure covering function which in particular is to improve the break-in security, also a reinforcement function to improve the crash safety of the vehicle door in that the component part is connected to the window pane or to the window lifter and at a predeterminable position of the window pane or window lifter, preferably in the upper end position of the window pane or window lifter, produces at least a force-locking connection between the door shells.

In a first variation the component part has connecting arms associated with the door shells whose contour coincides substantially with the contour of the door shells in the engagement region of the component part with the door shells.

To guard against break-in the component part extends at least over the region of the door lock and/or of the parts connected to the door lock such as rod linkage, Bowden cables and the like.

Furthermore the contour of the connecting arms, at least those of the connecting arm directed towards the door outer shell include a drainage channel and thus protects the door fittings from damp.

The component part preferably consists of safety elements connected to the door shells and a connecting element which is connected to the window pane or window lifter and is preferably fixed to the lower edge of the window pane or window lifter so that in a predeterminable position of the window pane or window lifter, preferably in the upper end position of the window pane or window lifter the connecting element connects at least with force locking engagement with the safety elements which are riveted or welded onto the door shells or are formed as a part of an extruded pressed profile of the door shells.

The connection between the safety elements and the connecting element can be provided through securing bolts. Alternatively the safety elements can be punctured or slit in the connecting region with the connecting element whilst the connecting element has engagement sections which are aligned with the holes or slits of the safety elements and engage in the safety elements in the predetermined more particularly uppermost position of the window pane or window lifter.

Furthermore the safety elements and connecting element can produce a positive locking connection in the form of a toothed engagement.

It is essential when embodying the solution according to the invention that the component is designed as a force-transferring component and/or a component covering the door gap.

Overall the solution according to the invention involves a reduction in the skeleton weight of the vehicle door, a considerable improvement in anti-theft protection, an improvement in the front and side impact situation of the vehicle door, enables additional functions for the window pane, for example through integrating wiper, washing and cleaning devices and protects the interior of the door body or door shaft through the integration of a water drainage channel in the force-transferring component so that function elements of a vehicle door mounted inside the door shaft are protected better from damp independently of whether they are mounted in the wet or dry space of the door shaft.

### BRIEF DESCRIPTION OF THE DRAWINGS

The invention will now be described in further detail with reference to several embodiments illustrated in the figures in the drawings

FIG. 1 is a perspective exploded view of a motor vehicle door;

FIG. 2 is a vertical section through the motor vehicle door according to FIG. 1;

FIG. 3 is a sectional view through the door body of a motor vehicle door in the region of the door shaft strip with a swivel component mounted between the window pane and door outer shell;

FIG. 4 is a section as in FIG. 3 with a component connected to the door outer shell and in sliding contact against the window pane;

FIG. 5 is a sectional view through the door body in the region of the door shaft strip with a component fixed on the lower edge of the window pane for transferring force and connecting the door outer shell to the door inner shell;

FIG. 6 a sectional view as in FIG. 5 with a multi-part force-transferring component whose parts are connected together with positive engagement in the upper closing position of the window pane;

FIG. 7 a sectional view through a door body in the region of the door shaft strip with a component as in FIG. 6 with punctured or slit connection of the individual parts of the component;

FIG. 8 is a plan view of a connecting arm of the force-transferring component connected to a door shell;

FIG. 9 is a sectional view through a door body in the region of the door shaft strip with a component as in FIG. 8 with structural means for reducing the distance from the door shells;

FIG. 10 is a perspective view of the connection of a safety element with the connecting element of a force-transferring component;

FIG. 11 is an enlarged partial view of a safety element and a part of the connecting element and

FIG. 12 is a diagrammatic partial view of the connection between a connecting element and safety elements of a force-transferring component.

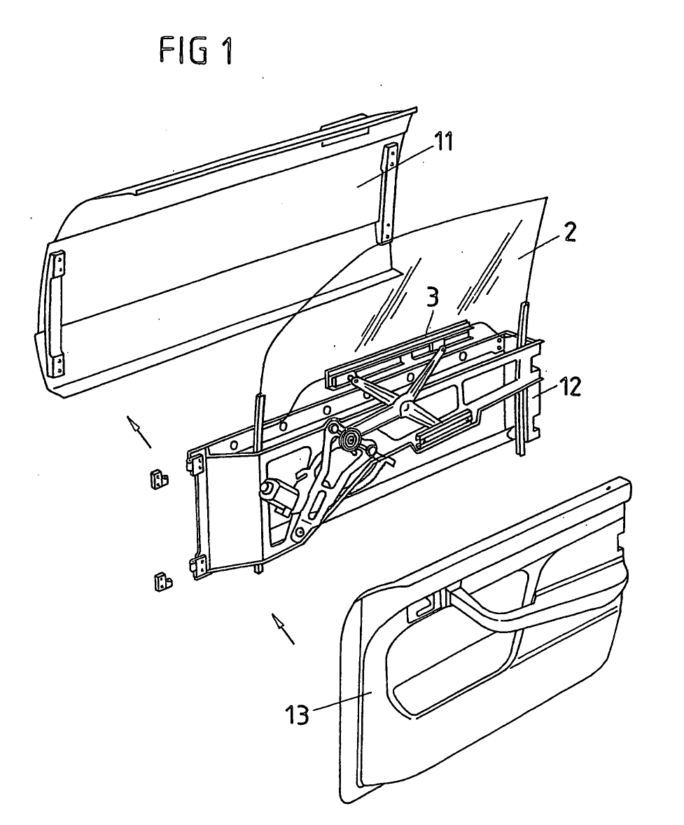

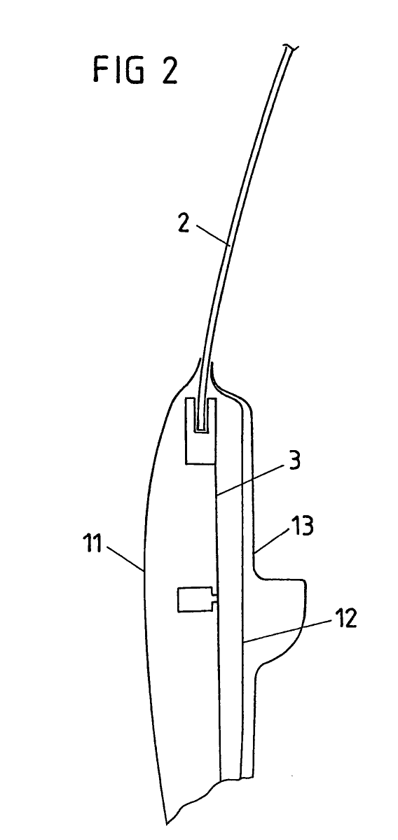

### DETAILED DESCRIPTION

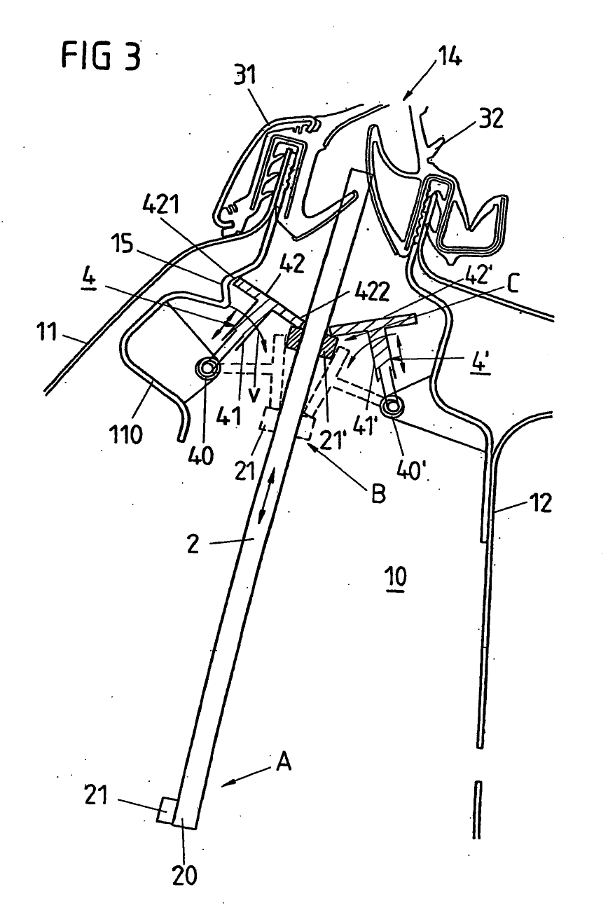

FIG. 3 shows a section through a door body in the region of the door shaft strip 14 in which are arranged sealing elements 31, 32 which are connected to the door outer shell 11 and door inner shell 12 respectively and bear against a window pane 2 which is movable in the direction of the double arrow and can be raised from the door shaft 10 or lowered into the door shaft 10. The window pane 2 is shown in three different movement sections A, B and C, namely in a position A lowered into the door shaft 10, a central position B and an uppermost position C, that is lifted substantially out of the door shaft 10.

A component 4 fixed for rotational or swivel movement on the door outer shell 11 or ledge reinforcement 110 of the door outer shell 11 , as well as a component 4′ fixed on the door inner shell 12, likewise for rotational or swivel movement, have a length-adjustable swivel arm 41, 41′ respectively and a bridging arm 42, 42′ running substantially perpendicular to the length-adjustable swivel arm 41, 41′ and mounted at the end opposite the connecting point of the swivel arm 41, 41′ on the ledge reinforcement 110 of the door outer shell 11 or door inner shell 12. The swivel arms 41, 41′ are designed as telescopic arms and have a sliding joint so that the distance between the bridging arms 42, 42′ and the connections of the swivel arms 41, 41′ is variable.

As a result of a torsion spring 40, 40′ mounted on the connecting points of the components 4, 4′ the components 4, 4′ are pretensioned in the direction of the arrow V and with the upper side of the bridging arms 42, 42′ bear against the outside face of the window pane 2 when the latter is located in the door shaft 10.

Followers or catches 21, 21′ are fixed each side on the lower edge 20 of the window pane 2 and change their position as the window pane is raised so as to stop in position B of the window pane 2 against the one end 422 of the bridging arms 42, 42′ of the component 4. In this position of the components 4, 4′, shown in dotted lines, further lifting of the window pane 2 leads to a swivel movement of the components 4, 4′ against the pretensioning direction V until they in the uppermost position C of the window pane 2, that is in their fully extended position out from the door shaft 10, are turned with the other end 421 of the bridging arms 42, 42′ into a relieved section 15 of the ledge reinforcement 110 of the door outer shell 11 or door inner shell 12.

In this position the components 4, 4′ are blocked between the followers 21, 21′ and the relieved section 15 as well as a similar relieved section of the door inner shell 12 and seal the door shaft 10 from intervention through the seal 31 connected to the door outer shell 11 and the seal 32 connected to the door inner shell 12. The security against a break-in through engagement through the door shaft strip 14 is thereby significantly increased since the door lock located in the door shaft 10 cannot be manipulated through the gap formed in the region of the door shaft 14 between the window pane 2 and door outer shell 11 or door inner shell 12.

The ends 422 of the bridging arms 42, 42′ on which the followers 21, 21′ engage are preferably provided with a slide member in order to reduce the friction between the surface of the window pane 2 and the bridging arms 42, 42′.

Although to guard against theft the arrangement of only one component 4 between the door inner shell 12 and window pane 2 is sufficient, extra security is provided through the arrangement of a component 4′ with a substantially coinciding function as the component 4 with a corresponding configuration of the follower 21′ fixed on the lower edge 20 of the window pane 2. Furthermore in the uppermost position of the window pane 2, i.e. in position C according to FIG. 3 a force-transferring connection is also produced through the components 4, 4′ between the door outer shell 11 and the door inner shell 12 which is transferred through the followers 21, 21′ which are fixed either side on the lower edge 20 of the window pane 2. When the window pane 2 is lowered this arrangement also improves the security against intervention through the door shaft strip 14 in the region between the window pane 2 and door inner shell 12 where for example door components mounted in this region could be manipulated.

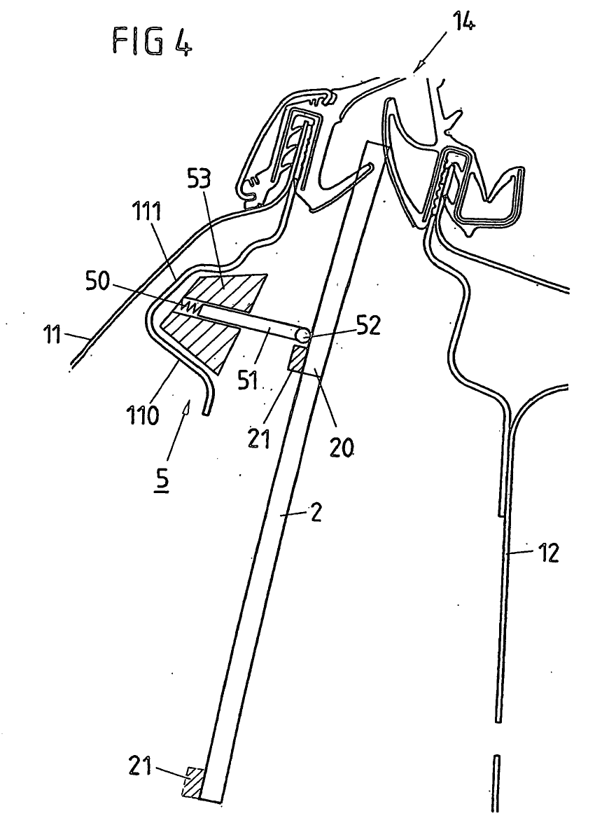

The component 5 illustrated in FIG. 4 has a similar function to the component 4 illustrated in FIG. 3 although it is not fixed for swivel action on the door outer shell but is mounted with a base body 53 in a recess 111 in the ledge reinforcement 110 of the door outer shell 11. A securing arm 51 of the component 5 is guided in the base body 53 substantially perpendicular to the plane of the window pane 2 and is supported with spring elasticity against same by means of a compression spring 50 so that the securing arm 51 is supported by its end opposite the compression spring 50 on the outside of the window pane 2 preferably through a slide member or slide roller 52. As a result of the guide of the securing arm 51 in the base body 53 sufficient strength and securing against bending of the securing arm 51 is provided so that intervention into the door shaft 20 through the door shaft strip 14 is at least made considerably more difficult.

Additional securing against outside intervention can be achieved similar to the arrangement according to FIG. 3 through a follower 21 which is connected to the lower edge 20 of the window pane 2 and in the uppermost position of the window pane 2 bears fixedly against the securing arm 51 so as to prevent the securing arm 51 from bending round or down.

The component 4 and 5 shown in FIGS. 3 and 4 respectively can additionally be connected to a pane wiper and/or washer device which cleans the surface of the window pane 2 during each movement of the window pane 2.

Also in the embodiment illustrated in FIG. 4 a component corresponding to the component 5 is mounted between the door inner shell 12 and the window pane 2 so that in the uppermost position of the window pane 2 a direct connection is produced between two components through the pane lower edge 20 or follower 21 fixed on the pane lower edge 20 which increases the crash safety of the vehicle door through the force-locking connection between the door shells 11, 12.

In order to avoid force transfer through the window pane 2 the follower 21 can be formed on the lower edge 20 of the window pane 2 so that the securing arms 51 in the uppermost position of the window pane 2 engage in corresponding recess of the follower 21 and thus produce a direct force-locking connection of the securing arms through the follower 21.

FIG. 5 shows in a sectional view through the door body in the region of the door shaft strip 14 a further variation of the solution according to the invention in which the lower edge 20 of the window pane 2 is connected to a force-transferring component 6 which in the uppermost position of the window pane 2 produces a force locking connection between the ledge reinforcements 110,120 of the door outer shell 11 and the door inner shell 12. For this purpose the component 6 has a connecting section 60 which engages round the lower edge 20 as well as either side of the connecting section 60 connecting arms 61, 62 which correspond to the contour of recesses or indentations 111, 121 of the ledge reinforcements 110, 120 of the door outer shell 11 and the door inner shell 12.

The contours of the connecting arms 61, 62 are thereby selected so that water drainage channels 63, 64 are formed which like a roof gutter prevent moisture entering through the door shaft strip 14 from running onto door components mounted in the door body.

Through the direct connection of the ledge reinforcements 110, 120 of the door shells 11, 12 by means of the force-transferring component 6 in the uppermost position of the window pane 2 and as a result of combining the inherent rigidity of the door shells 11, 12 the safety against a side impact crash in the direction of arrow K is clearly increased and additionally there is better prevention against intervention from outside for example in the direction of arrow T in the region between the door outer shell 11 and window pane 2 in the region of the door shaft strip 14.

As an alternative to fixing the component part 6 on the lower edge 20 of the window pane 2 as illustrated in FIG. 5 the component can be fixed directly on the window lifter for lifting and lowering the window pane 2 whereby the type of window lifter is immaterial, i.e. whether a cross-arm or cable window lifter. Furthermore the component 6 can be fixed on a continuous rail connected to the lower edge 20 of the window pane.

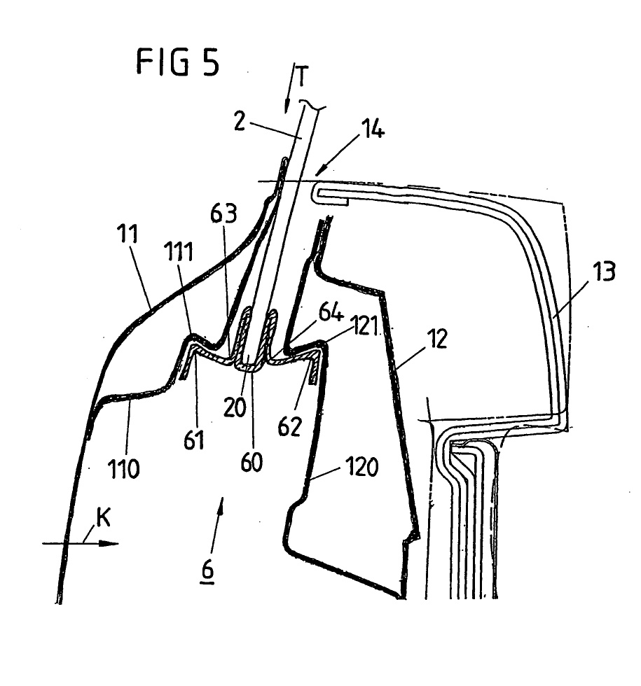

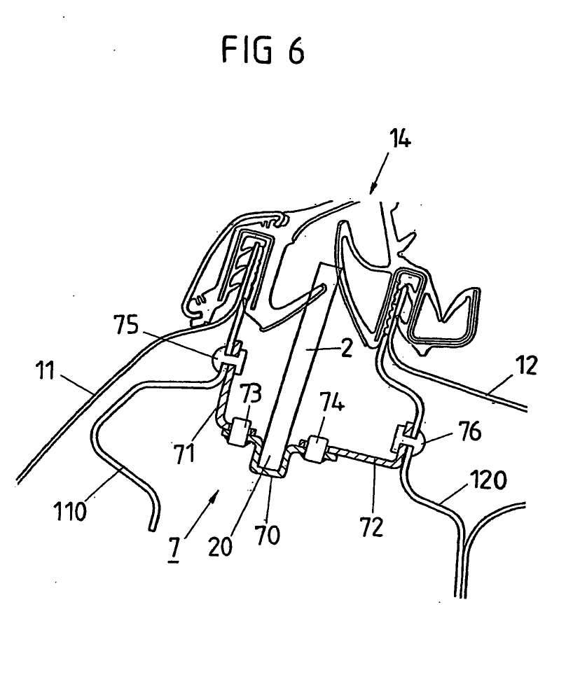

FIG. 6 shows an embodiment in which the force-transferring component part 7 does not engage positively with securing arms into corresponding positive locking regions of the door shells 11, 12 but is designed multi-part and in the closing position of the window pane 2 produces a positive locking connection between its individual components.

The force-transferring component 7 consists of a connecting element 70 connected to the lower edge 20 of the window pane 2 or to a suitable part of a window lifter for lifting and lowering the window pane 2, and of a safety element 71, 72 which is connected to the ledge reinforcement 110 of the door outer shell 11 or ledge reinforcement 120 of the door inner shell 12 and which in the closing position of the window pane engages through securing bolts 73, 74 into the connecting element 70. The safety elements 71, 72 are connected by rivets 75, 76 to the ledge reinforcements 110, 120 of the door shells 11,12 or are welded or stuck to same.

The connection of the connecting element 70 to the lower edge 20 of the window pane 2 can be achieved through adhesive or positive engagement or through adhesive and positive engagement or through a pin or screw connection.

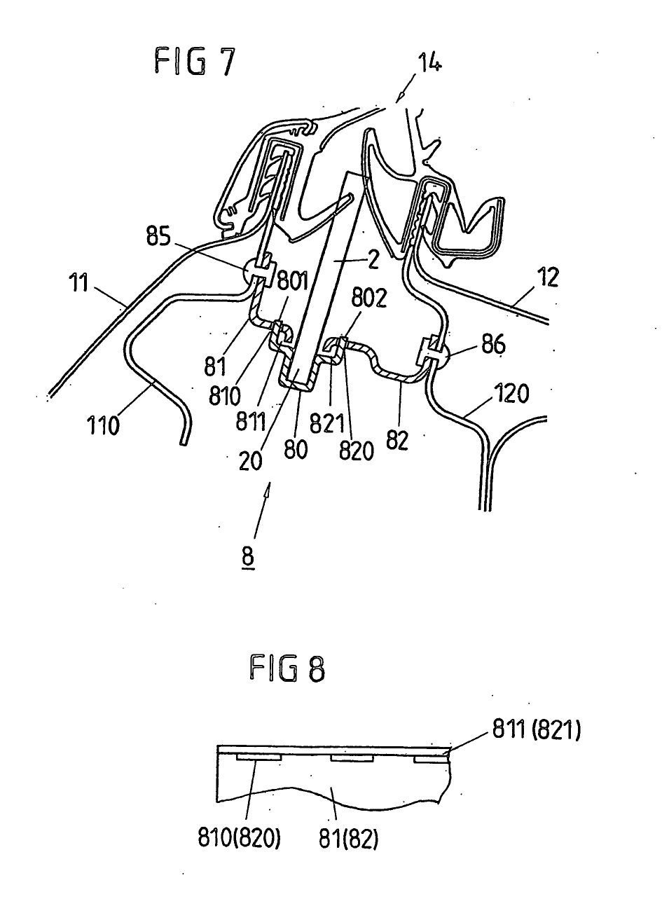

FIG. 7 shows a component 8 which connects the door shells 11, 12 together in the closing position of the window pane 2 with force locking engagement and which consists of a connecting element 80 connected to the lower edge 20 of the window pane 2, and of securing arms 81, 82 which are connected to the ledge reinforcements 110, 120 of the door shells 11, 12 and which in the closed position of the window pane 2 engage with positive locking connection into the connecting element 80. The securing arms 81, 82 are connected through rivet or screw connections 85, 86 to the ledge reinforcements 110, 120 of the door shells 11, 12 and have according to FIG. 8 slits 810, 820 in which corresponding comb-like projections 801, 802 of the connecting element 80 engage. In order to produce a secured positive locking connection in the engaged state of the connecting element 80 with the securing arms 81, 82 the ends of the securing arms 81, 82 have bent parts 811, 821 which secure the positive locking and force locking connection between the connecting element 80 and securing elements 81, 82.

Also in this embodiment the connecting element 80 can be connected alternatively or additionally to a window lifter which moves the window pane 2.

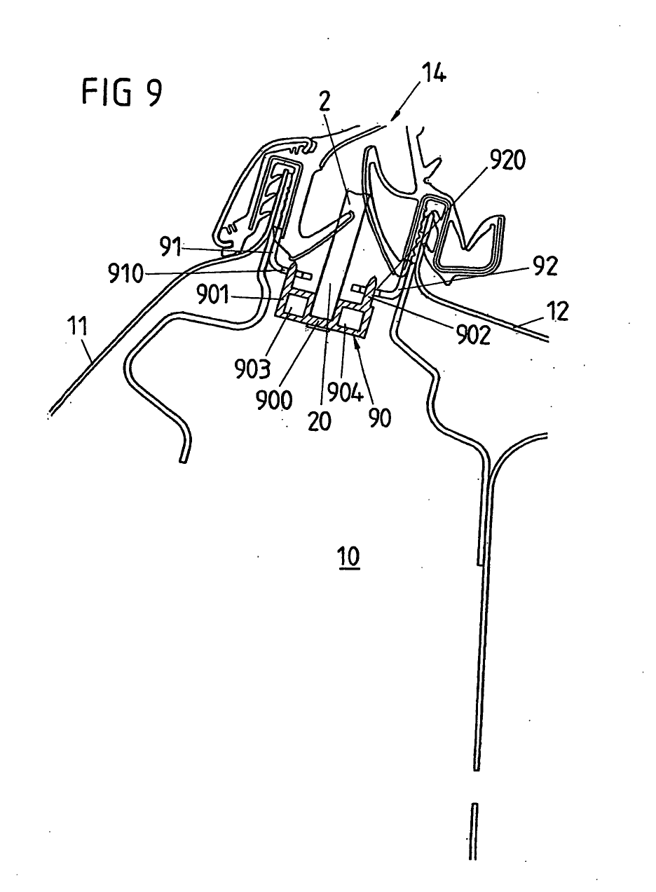

FIG. 9 likewise shows a section through a door shaft 10 of a door body in the region of the door shaft strip 14 with a force-transferring component 9 which each has a connecting element 90 and a securing element 91, 92 connected to the door outer shell 11 and door inner shell 12. The securing elements 91, 92 can be designed as extruded pressed profiles and can be a part of the outer shell 11 and inner shell 12 respectively. The connecting element 90 is connected to the lower edge 20 of the window pane 2 in that it is stuck by way of example to the lower edge 20 by a region 900 embracing the lower edge 20.

The connecting element 90 has two connecting arms 903, 904 which are designed as box profiles running along the free lower edge in order to reduce the distance of the connecting element from the ledge reinforcements 110, 120 of the door outer shell 11 and door inner shell 12 which additionally through profiling provide a minimum distance from the connecting arms 903, 904.

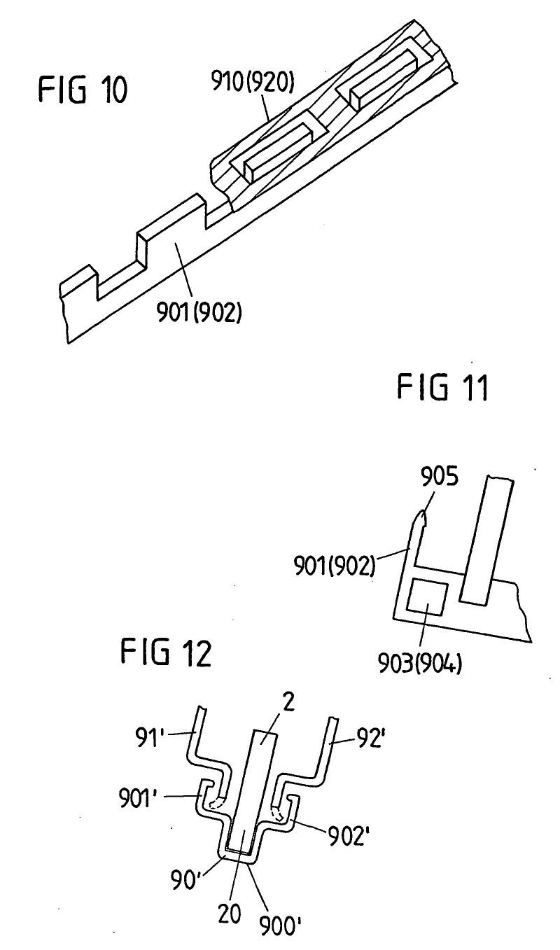

The connection between the connecting arms 903, 904 and the securing elements 91, 92 is produced according to FIG. 10 as a type of toothed engagement in which teeth 901, 902 protruding from the connecting arms 90, 904 of the connecting element 90 engage in recesses 910, 920 of the securing elements 91, 92. Through this connection between the connecting element 90 and the securing elements 91, 92 which runs over the entire length of the pane lower edge a large engagement and connecting surface area is ensured which takes up the front and side impact forces. The box profile of the securing elements 91, 92 thereby serves additionally as side impact support to break down the side impact forces acting on the vehicle door.

The teeth 901 of the connecting arms 903, 904 of the connecting element 90 can according to FIG. 11 be provided with a relieved section 905 in order to ensure the engagement of the teeth 901, 902 in the recesses 910, 920 of the securing elements 91, 92 designed as counter profiles.

FIG. 12 shows diagrammatically a further variation of the connection between a connecting element 90′ and the securing elements 91′, 92′ in which a positive engagement is produced in the Y-direction of the vehicle without bores or recesses and which is particularly suitable in a design as an extruded pressed profile. The ends of the connecting arms 901′, 902′ of the connecting element 9′ which is placed with a region 900′ around the lower edge 20 of the window pane 2 and is connected to same through adhesive thereby engage round the ends of the securing elements 91′, 92′ in the manner of a clip and thereby produce a force-transferring connection between the door shells 11, 12 according to FIG. 9.

The embodiments described above clearly show the different possibilities for embodying the idea on which the invention is based for securing a vehicle door against break-in and for improving the front and side impact protection. Common to all the embodiments is the closing of the upper door shaft slit at least when the window pane is completely lifted out from the door shaft so that an effective anti-theft protection is guaranteed. Alternative embodiments additionally provide a force-transferring connection between the door shells of the vehicle door so that front and side impact forces are better absorbed through an increase in the inherent strength of the door body. The additional material and assembly expense is slight compared to additional measures otherwise required to cover the lock to improve the anti-theft protection or to increase the inherent strength of the door shells through corresponding profiling and stronger materials which lead to an increase in the inherent weight of the vehicle door and thus of the vehicle itself.

1-23. (canceled)

24. A motor vehicle door with a door body comprising a door outer shell and a door inner shell between which a door shaft is formed in which a window lifter is mounted for lifting and lowering a window pane,
wherein
at least one component which is mounted inside the door shaft produces a transverse connection between one of the window pane and the window lifter and at least one of the door outer shell and the door inner shell at least over a part of a width, running in a longitudinal direction of the vehicle door, the window pane, the window lifter, the door outer shell and the door inner shell.

25. The motor vehicle door according to claim 24, wherein the at least one component is connected to the at least one of the door outer shell and the door inner shell and is supported spring elastically on the one of the window pane and the window lifter.

26. The motor vehicle door according to claim 25, wherein the at least one component comprises a component which changes its position with movement of the one of the window pane and the window lifter and which with a predetermined position of the one of the window pane and the window lifter connects positively with the at least one of the door outer shell and the door inner shell.

27. The motor vehicle door according to claim 26, wherein the component bears with pretension against the one of the window pane and the window lifter and during lifting of the one of the window pane and the window lifter swivels out from the door shaft by one of a follower and a support mounted on the one of the window pane and the window lifter into a force-transferring position with a door shell.

28. The motor vehicle door according to claim 27, wherein the component has a length-variable swivel arm and a bridging arm connected to the swivel arm, of which one end of the swivel arm bears through a slide member against the one of the window pane and the window lifter and whose other end, for connecting with the at least one of the door outer shell and the door inner shell, with a predetermined position of the one of the window pane and the window lifter, engages in a relieved section of the at least one of the door outer shell and the door inner shell.

29. The motor vehicle door according to claim 28, wherein the swivel arm comprises a telescopic arm and is attached to the at least one of the door outer shell and the door inner shell and is pretensioned through a torsion spring against one of the window pane and the window lifter.

30. The motor vehicle door according to claim 25, wherein the at least one component is supported movable substantially at right angles to the one of the window pane and the window lifter and is supported spring elastically against the one of the window pane and the window lifter.

31. The motor vehicle door according to claim 30, wherein the at least one component in a fully raised position of the one of the window pane and the window lifter bears against one of a follower and a support connected to the one of the window pane and the window lifter.

32. The motor vehicle door according to claim 24, wherein the at least one component is connected to one of a windscreen wiper and a wash device.

33. The motor vehicle door according to claim 24, wherein the at least one component is connected to the one of the window pane and the window lifter and with a predeterminable position of the one of the window pane and the window lifter, produces at least a force locking engagement between the door outer shell and the door inner shell.

34. The motor vehicle door according to claim 33, wherein the at least one component has connecting arms associated with the door outer shell and the door inner shell, the connecting arms having contours that substantially coincide with the contours of the door shells in engagement regions of the component with the door shells.

35. The motor vehicle door according to claim 34, wherein the component extends at least over region of a door lock and parts connected to the door lock.

36. The motor vehicle door according to claim 34, wherein the contour at least of the connecting arm directed to the door outer shell includes a water drainage channel.

37. The motor vehicle door according to claim 33, wherein the at least one component comprises securing elements connected to door inner shell shells and of a connecting element connected to the one of the window pane and the window lifter, which in a predeterminable position of the one of the window pane and the window lifter is connected at least with force locking connection to the securing elements.

38. The motor vehicle door according to claim 37, wherein the securing elements are riveted or welded to the door shells or are part of an extruded pressed profile of the door shells.

39. The motor vehicle door according to claim 37, wherein the connecting element is fixed on a lower edge of the one of the window pane and the window lifter.

40. The motor vehicle door according to claim 37, wherein the securing elements are connected to the connecting element through securing bolts.

41. The motor vehicle door according to claim 37, wherein the securing elements are punctured and slit in a connection region with the connecting element and wherein the connecting element engages in the securing elements by engagement sections aligned with holes and slits of the securing elements in the predeterminable position of the one of the window pane and the window lifter.

42. The motor vehicle door according to claim 37, wherein the securing elements in an engagement region with the connecting element make a force-transferring connection with the connecting element at least in a transverse direction (y-axis) of the motor vehicle.

43. The motor vehicle door according to claim 37, wherein the securing elements and the connecting element produce a positive locking engagement through a toothed connection.

44. The motor vehicle door according to claim 37, wherein the connecting element has connecting arms with a box profile running parallel to a lower edge of the window pane.

45. The motor vehicle door according to claim 24, wherein the at least one component part is designed as a force-transferring component and a component covering the door gap.

46. The motor vehicle door according to claim 24, wherein a predeterminable position of the one of the window pane and the window lifter for producing a positive locking and force locking connection between the one of the window pane and the window lifter and door inner shell and directly between door inner shell is an uppermost position of the one of the window pane and the window lifter in which the window pane closes a door cut out section of the vehicle door.

47. The motor vehicle door of claim 33, wherein the predeterminable position comprises an upper end position of the one of the window pane and the window lifter.

48. The motor vehicle door of claim 35, wherein the parts connected to the door lock comprise a rod linkage and a Bowden cable.

49. The motor vehicle door of claim 37 wherein the parts connected to the door lock comprise a rod linkage and a Bowden cable.
